(19) United States
(12) Patent Application Publication
(10) Pub. No.: US 2026/0202245 A1
(43) Pub. Date: Jul. 16, 2026

(54) MEASUREMENT APPARATUS, MEASUREMENT METHOD, AND PROGRAM

(71) Applicant: Yokogawa Test & Measurement Corporation, Tokyo (JP)

(72) Inventor: Hiroaki Matsukawa, Tokyo (JP)

(73) Assignee: Yokogawa Test & Measurement Corporation, Tokyo (JP)

(21) Appl. No.: 19/387,794

(22) Filed: Nov. 13, 2025

(30) Foreign Application Priority Data
Jan. 10, 2025 (JP) 2025-004322

(51) Int. Cl. G01J 3/02; G01J 3/18; G01J 3/28

(52) U.S. Cl. CPC G01J 3/0262; G01J 3/18; G01J 3/2803

(57) ABSTRACT

A measurement apparatus (10) includes a spectroscope (11) configured to extract a specific wavelength component from incident light, a photodetector (13) configured to output a signal according to an intensity of the extracted wavelength component, and a processor (16). The processor (16) is configured to acquire, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and output a difference between the second signal and the first signal as an optical spectrum of the wavelength interval.

### CROSS-REFERENCE TO RELATED APPLICATION

The present application claims priority to Japanese Patent Application No. 2025-004322 filed on Jan. 10, 2025, the entire contents of which are incorporated herein by reference.

### TECHNICAL FIELD

The present disclosure relates to a measurement apparatus, a measurement method, and a program.

### BACKGROUND

An optical spectrum analyzer (OSA) is a device that measures the wavelength spectrum of incident light in a certain wavelength range. Patent Literature (PTL) 1 describes a spectrum analyzer that measures the spectrum of incident light chopped by a chopper.

### CITATION LIST

### Patent Literature

PTL 1: JP H7-23258 U

### SUMMARY

A measurement apparatus according to several embodiments is a measurement apparatus comprising:
a spectroscope configured to extract a specific wavelength component from incident light;
a photodetector configured to output a signal according to an intensity of the extracted wavelength component; and
a processor, wherein
the processor is configured to acquire, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and output a difference between the second signal and the first signal as an optical spectrum of the wavelength interval.

A measurement method according to several embodiments is a measurement method for a measurement apparatus comprising a spectroscope configured to extract a specific wavelength component from incident light, a photodetector configured to output a signal according to an intensity of the extracted wavelength component, and a processor, the measurement method comprising:
acquiring, by the processor, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and outputting a difference between the second signal and the first signal as an optical spectrum of the wavelength interval.

A program according to several embodiments is a program for controlling a measurement apparatus comprising a spectroscope configured to extract a specific wavelength component from incident light, a photodetector configured to output a signal according to an intensity of the extracted wavelength component, and a processor, the program being configured to control the measurement apparatus to execute processing comprising:
acquiring, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and outputting a difference between the second signal and the first signal as an optical spectrum of the wavelength interval.

### BRIEF DESCRIPTION OF THE DRAWINGS

In the accompanying drawings:

FIG. 1 is a block diagram illustrating a configuration example of a measurement apparatus according to an embodiment;

FIG. 2 is a diagram illustrating a configuration example of the spectroscope in FIG. 1;

FIG. 3 is a flowchart illustrating an example of the operation of the measurement apparatus according to an embodiment;

FIG. 4 is a schematic diagram illustrating an example of the operation of the measurement apparatus according to an embodiment;

FIG. 5 is a schematic diagram illustrating an example of the operation of the measurement apparatus according to an embodiment; and

FIG. 6 is a diagram illustrating an example of measurement results of the optical spectrum of pulsed light for each measurement method.

### DETAILED DESCRIPTION

Pulsed light is light that is outputted intermittently at a predetermined repetition period. A conventional configuration has room for improvement in the measurement accuracy of the optical spectrum of pulsed light.

It would be helpful to enable the optical spectrum of pulsed light to be measured with higher accuracy.

A measurement apparatus according to several embodiments is
(1) a measurement apparatus including:
a spectroscope configured to extract a specific wavelength component from incident light;
a photodetector configured to output a signal according to an intensity of the extracted wavelength component; and
a processor, wherein
the processor is configured to acquire, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and output a difference between the second signal and the first signal as an optical spectrum of the wavelength interval.

In this way, the measurement apparatus divides the wavelength range to be measured into a plurality of wavelength intervals, measures the incident light in a state in which light is blocked and a state in which light is not blocked for each wavelength interval, and outputs the difference between the measurement signals as the optical spectrum of the wavelength interval. Therefore, the measurement apparatus can suppress the effect of drift in the measurement value due to the dark current and can measure the optical spectrum of the pulsed light with higher accuracy.

In one embodiment,
(2) in the measurement apparatus of (1),
the length of each wavelength interval in the plurality of wavelength intervals may be determined according to a magnitude of fluctuation in a measurement value caused by a dark current in the photodetector during measurement of the optical spectrum in the wavelength interval.

In this way, the length of each wavelength interval is determined according to the magnitude of the fluctuation in the measurement value due to the dark current in the photodetector. The measurement apparatus can therefore effectively reduce the effect of drift in the measurement value due to the dark current.

In one embodiment,
(3) in the measurement apparatus of (1) or (2),
the processor may divide the wavelength range to be measured by using, as the wavelength intervals, intervals received as a setting from an operator via an operation interface.

In this way, the measurement apparatus divides the wavelength range to be measured by using, as the wavelength intervals, intervals received as a setting from the operator, thereby enabling the operator to set the desired wavelength interval according to the characteristics of the photodetector and measure the optical spectrum.

In one embodiment,
(4) in the measurement apparatus of any one of (1) to (3),
the processor may
   receive a setting of a time average interval from an operator via an operation interface, and
   acquire, for each wavelength interval in the plurality of wavelength intervals, a signal obtained by averaging signals outputted from the photodetector in a state in which light is blocked for each time average interval as the first signal, and a signal obtained by averaging signals outputted from the photodetector in a state in which light is not blocked for each time average interval as the second signal.

In this way, the measurement apparatus receives the time average interval setting from the operator and acquires the optical spectrum for each wavelength interval based on the averaged signals for each time average interval. Thus, the operator can measure the optical spectrum at the desired sampling rate.

In one embodiment,
(5) in the measurement apparatus of any one of (1) to (4),
the processor may be configured to acquire, for each wavelength interval in the plurality of wavelength intervals, the first signal outputted from the photodetector in a state in which light is blocked, and then acquire the second signal outputted from the photodetector in a state in which light is not blocked.

In this way, the measurement apparatus performs a measurement in a state in which light is blocked, and then performs a measurement in a state in which light is not blocked. Therefore, it is possible to minimize the effect of drift caused by dark current due to a rise in temperature of the photodetector caused by light being incident on the photodetector.

In one embodiment,
(6) the measurement apparatus of any one of (1) to (5) may further comprise
an optical chopper configured to block light incident on the photodetector, wherein
the processor may acquire, for each wavelength interval in the plurality of wavelength intervals, a signal outputted from the photodetector in a state in which light is blocked by the optical chopper as the first signal, and acquire a signal outputted from the photodetector in a state in which light is not blocked by the optical chopper as the second signal.

In this way, the measurement apparatus can easily use the optical chopper to switch between a state in which light is blocked and a state in which light is not blocked.

A measurement method according to several embodiments is
(7) a measurement method for a measurement apparatus, the measurement apparatus comprising a spectroscope configured to extract a specific wavelength component from incident light, a photodetector configured to output a signal according to an intensity of the extracted wavelength component, and a processor, the measurement method comprising:
acquiring, by the processor, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and outputting a difference between the second signal and the first signal as an optical spectrum of the wavelength interval.

In this way, the measurement method divides the wavelength range to be measured into a plurality of wavelength intervals, measures the incident light in a state in which light is blocked and a state in which light is not blocked for each wavelength interval, and outputs the difference between the measurement signals as the optical spectrum of the wavelength interval. Therefore, the measurement method can suppress the effect of drift in the measurement value due to the dark current and can measure the optical spectrum of the pulsed light with higher accuracy.

In one embodiment,
(8) in the measurement method of (7),
the length of each wavelength interval in the plurality of wavelength intervals may be determined according to a magnitude of fluctuation in a measurement value caused by a dark current in the photodetector during measurement of the optical spectrum in the wavelength interval.

In this way, the length of each wavelength interval is determined according to the magnitude of the fluctuation in the measurement value due to the dark current in the photodetector. The measurement method can therefore effectively reduce the effect of drift in the measurement value due to the dark current.

In one embodiment,
(9) in the measurement method of (7) or (8),

the processor may divide the wavelength range to be measured by using, as the wavelength intervals, intervals received as a setting from an operator via an operation interface.

In this way, the measurement method divides the wavelength range to be measured by using, as the wavelength intervals, intervals received as a setting from the operator, thereby enabling the operator to set the desired wavelength interval according to the characteristics of the photodetector and measure the optical spectrum.

In one embodiment,
(10) in the measurement method of any one of (7) to (9),
the processor may
   receive a setting of a time average interval from an operator via an operation interface, and
   acquire, for each wavelength interval in the plurality of wavelength intervals, a signal obtained by averaging signals outputted from the photodetector in a state in which light is blocked for each time average interval as the first signal, and a signal obtained by averaging signals outputted from the photodetector in a state in which light is not blocked for each time average interval as the second signal.

In this way, the measurement method receives the time average interval setting from the operator and acquires the optical spectrum for each wavelength interval based on the averaged signals for each time average interval. Thus, the operator can measure the optical spectrum at the desired sampling rate.

In one embodiment,
(11) in the measurement method of any one of (7) to (10),
the processor may, for each wavelength interval in the plurality of wavelength intervals, acquire the first signal outputted from the photodetector in a state in which light is blocked, and then acquire the second signal outputted from the photodetector in a state in which light is not blocked.

In this way, the measurement method performs a measurement in a state in which light is blocked, and then performs a measurement in a state in which light is not blocked. Therefore, it is possible to minimize the effect of drift caused by dark current due to a rise in temperature of the photodetector caused by light being incident on the photodetector.

In one embodiment,
(12) in the measurement method of any one of (7) to (11),
the measurement apparatus may further comprise an optical chopper configured to block light incident on the photodetector, and
the processor may acquire, for each wavelength interval in the plurality of wavelength intervals, a signal outputted from the photodetector in a state in which light is blocked by the optical chopper as the first signal, and acquire a signal outputted from the photodetector in a state in which light is not blocked by the optical chopper as the second signal.

In this way, the measurement method can easily use the optical chopper to switch between a state in which light is blocked and a state in which light is not blocked.

A program according to several embodiments is
(13) a program for controlling a measurement apparatus, the measurement apparatus comprising a spectroscope configured to extract a specific wavelength component from incident light, a photodetector configured to output a signal according to an intensity of the extracted wavelength component, and a processor, the program being configured to control the measurement apparatus to execute processing comprising:
acquiring, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and outputting a difference between the second signal and the first signal as an optical spectrum of the wavelength interval.

In this way, the program divides the wavelength range to be measured into a plurality of wavelength intervals, measures the incident light in a state in which light is blocked and a state in which light is not blocked for each wavelength interval, and outputs the difference between the measurement signals as the optical spectrum of the wavelength interval. Therefore, the program can suppress the effect of drift in the measurement value due to the dark current and can measure the optical spectrum of the pulsed light with higher accuracy.

In one embodiment,
(14) in the program of (13),
the length of each wavelength interval in the plurality of wavelength intervals may be determined according to a magnitude of fluctuation in a measurement value caused by a dark current in the photodetector during measurement of the optical spectrum in the wavelength interval.

In this way, the length of each wavelength interval is determined according to the magnitude of the fluctuation in the measurement value due to the dark current in the photodetector. The program can therefore effectively reduce the effect of drift in the measurement value due to the dark current.

In one embodiment,
(15) in the Program of (13) or (14),
the processing may comprise dividing the wavelength range to be measured by using, as the wavelength intervals, intervals received as a setting from an operator via an operation interface.

In this way, the program divides the wavelength range to be measured by using, as the wavelength intervals, intervals received as a setting from the operator, thereby enabling the operator to set the desired wavelength interval according to the characteristics of the photodetector and measure the optical spectrum.

In one embodiment,
(16) in the program of any one of (13) to (15), the processing may comprise
receiving a setting of a time average interval from an operator via an operation interface, and
acquiring, for each wavelength interval in the plurality of wavelength intervals, a signal obtained by averaging signals outputted from the photodetector in a state in which light is blocked for each time average interval as the first signal, and a signal obtained by averaging signals outputted from the photodetector in a state in which light is not blocked for each time average interval as the second signal.

In this way, the program receives the time average interval setting from the operator and acquires the optical spectrum for each wavelength interval based on the averaged signals for each time average interval. Thus, the operator can measure the optical spectrum at the desired sampling rate.

In one embodiment,
(17) in the program of any one of (13) to (16), the processing may comprise
acquiring, for each wavelength interval in the plurality of wavelength intervals, the first signal outputted from the photodetector in a state in which light is blocked, and then acquiring the second signal outputted from the photodetector in a state in which light is not blocked.

In this way, the program performs a measurement in a state in which light is blocked, and then performs a measurement in a state in which light is not blocked. Therefore, it is possible to minimize the effect of drift caused by dark current due to a rise in temperature of the photodetector caused by light being incident on the photodetector.

In one embodiment,
(18) in the program of any one of (13) to (17),
the measurement apparatus may further comprise an optical chopper configured to block light incident on the photodetector, and
the processing may comprise acquiring, for each wavelength interval in the plurality of wavelength intervals, a signal outputted from the photodetector in a state in which light is blocked by the optical chopper as the first signal, and acquiring a signal outputted from the photodetector in a state in which light is not blocked by the optical chopper as the second signal.

In this way, the program can easily use the optical chopper to switch between a state in which light is blocked and a state in which light is not blocked.

According to an embodiment of the present disclosure, the optical spectrum of pulsed light can be measured with higher accuracy.

### Embodiment

An embodiment of the present disclosure will be described below, with reference to the drawings. In each drawing, parts having the same configuration or function are labeled with the same reference numerals. In the description of the present embodiment, repetitive descriptions of the same parts may be omitted or simplified as appropriate.

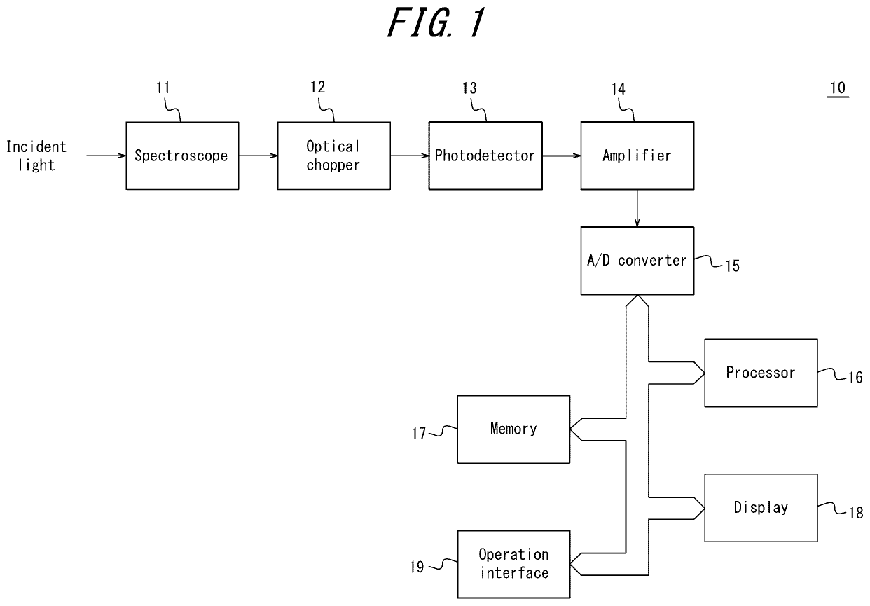

FIG. 1 is a block diagram illustrating a configuration example of a measurement apparatus 10 according to an embodiment. The measurement apparatus 10 measures an optical spectrum, which is the distribution of the intensity of incident light for each wavelength. The measurement apparatus 10 may be provided as an OSA. In the present embodiment, the measurement apparatus 10 measures the optical spectrum of pulsed light outputted from a pulse laser. The measurement apparatus 10 includes a spectroscope 11, an optical chopper 12, a photodetector 13, an amplifier 14, an A/D (Analog-to-Digital) converter 15, a processor 16, a memory 17, a display 18, and an operation interface 19.

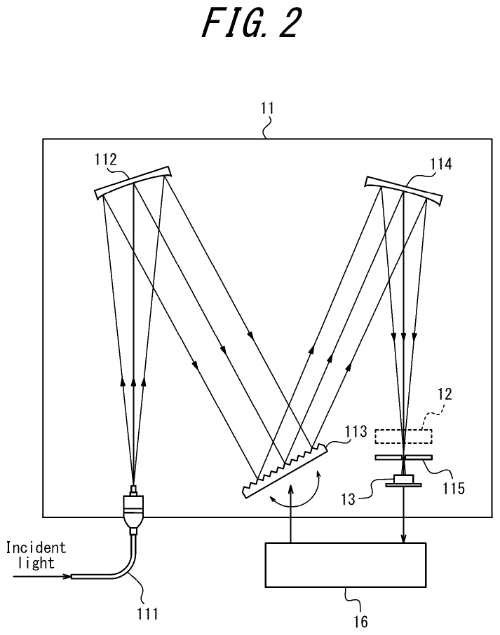

The spectroscope 11 extracts a desired frequency component from the incident light. The spectroscope 11 is, for example, configured with a monochromator (FIG. 2) described below, but may be realized with any device having the function of a spectroscope.

The optical chopper 12 modulates the incident light by a rotating light blocking plate and a slit. The optical chopper 12 can block the incident light by positioning the light blocking plate in the optical path, or can transmit the incident light by positioning the slit in the optical path. The measurement apparatus 10 can arbitrarily change the period during which the incident light can reach the photodetector 13 by controlling the rotation speed of the optical chopper 12.

The photodetector 13 outputs an electrical signal according to the intensity of the incident light. The photodetector 13 is realized by a photoelectric conversion element such as a photodiode. An element capable of detecting light of the wavelength to be measured is selected as the photodetector 13.

As will be described later with reference to FIG. 2, in the present embodiment, the optical chopper 12 and the photodetector 13 are provided inside the spectroscope 11, but the present disclosure is not limited to this configuration. For example, the optical chopper 12 may be provided at any position on the optical path before the incident light reaches the photodetector 13. The optical chopper 12 may, for example, be provided prior to the spectroscope 11.

The amplifier 14 amplifies the electrical signal outputted by the photodetector 13 to a predetermined range. The amplifier 14 outputs the amplified electrical signal to the A/D converter 15.

The A/D converter 15 converts the analog electrical signal amplified by the amplifier 14 into a digital signal. The A/D converter 15 outputs the electrical signal converted into a digital signal to the processor 16.

The processor 16 is configured to include one or more processors or dedicated circuits. In the present embodiment, the processor 16 can be a general-purpose processor, a dedicated processor specialized for particular processing, or the like, but the processor 16 is not limited to these examples. The dedicated circuit may include, for example, a field-programmable gate array (FPGA), an application specific integrated circuit (ASIC), or the like. The processor 16 is communicably connected to each component of the measurement apparatus 10 and controls the operation of the measurement apparatus 10 as a whole.

In the present embodiment, the processor 16 controls a series of processes to acquire the optical spectrum of the incident light based on the measurement values from the measurement of the incident light using the spectroscope 11, the optical chopper 12, the photodetector 13, and the like, but this configuration is not limiting. For example, a processor or dedicated circuit that is not built into the measurement apparatus 10 may act as the processor 16 to control the process of acquiring the optical spectrum of the incident light based on the measurement values.

The memory 17 stores any information used in the operation of the measurement apparatus 10. The memory 17 includes any storage module, such as a solid state drive (SSD), a read-only memory (ROM), and a random access memory (RAM).

The display 18 includes one or more output interfaces that output information to an operator to notify the operator. The display 18 may be, for example, a liquid crystal panel display or an organic EL (Electro Luminescence) display.

The operation interface 19 includes one or more input interfaces that receive an input operation from an operator and acquire input information based on the operation by the operator. For example, the operation interface 19 may be a physical key, a capacitance key, a touch screen that is integrated with the display of the display 18, or the like, but is not limited to these. At least one of the display 18 and the operation interface 19 may be configured integrally with the measurement apparatus 10, or each may be provided separately.

The functions of the measurement apparatus 10 can be realized by executing a computer program (program) according to the present embodiment on a processor included in the processor 16. That is, the functions of the measurement apparatus 10 can be realized by software. The computer program causes a computer to execute the processing of the steps included in the operation of the measurement apparatus 10, thereby causing the computer to realize the functions corresponding to the processing of each step. That is, the computer program is a program for causing a computer to function as the measurement apparatus 10 according to the present embodiment.

FIG. 2 is a diagram illustrating a configuration example of the spectroscope 11 in FIG. 1. FIG. 2 illustrates an example of the spectroscope 11 configured as a monochromator. The spectroscope 11 includes a collimating mirror 112, a diffraction grating 113, a focusing mirror 114, an exit slit 115, the optical chopper 12, and the photodetector 13. In the example in FIG. 2, incident light enters the spectroscope 11 via an optical fiber 111.

The collimating mirror 112 and the focusing mirror 114 are parabolic mirrors.

The diffraction grating 113 is configured by extremely fine grooves cut into a mirror. The diffraction grating 113 is an optical element that extracts light of a specific wavelength from light containing a mixture of various wavelengths. When light of various wavelengths is incident on the diffraction grating 113, diffraction occurs at a predetermined angle according to each wavelength. Therefore, the wavelength can be identified based on the diffraction angle from the diffraction grating 113.

The optical chopper 12 switches between blocking and transmitting (not blocking) light according to the control of the processor 16. The exit slit 115 adjusts the wavelength resolution, light amount, and the like of the spectroscope 11. The photodetector 13 photoelectrically converts the incident light and outputs an electrical signal according to the intensity of the incident light.

In the spectroscope 11, light incident from the optical fiber 111 is collimated by the collimating mirror 112 and is guided to the diffraction grating 113. The light diffracted by the diffraction grating 113 is focused by the focusing mirror 114 into a spectrum in the dispersion direction with the exit slit 115 as the center. Therefore, only light of the wavelength, within the spectrum, that is focused on the exit slit 115 will be detected by the photodetector 13. The wavelength of the light to be detected, i.e., the central wavelength of the optical bandpass filter, can be changed by rotating the diffraction grating 113. Therefore, the spectroscope 11 can measure the spectrum of the incident light by obtaining the relationship between the angle (tilt) of the diffraction grating 113 corresponding to the wavelength of the incident light and the intensity of the light detected by the photodetector 13.

In the example in FIG. 2, an optical chopper 12 is provided in the optical path between the focusing mirror 114 and the exit slit 115. The optical chopper 12 switches between blocking and transmitting the incident light under the control of the processor 16.

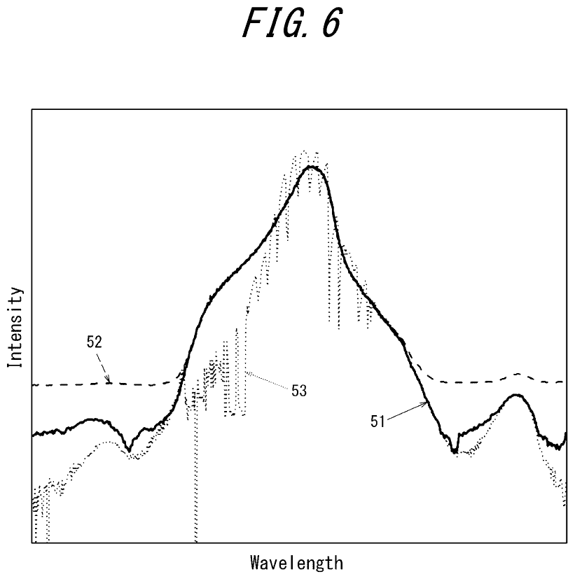

It is generally known that a photoelectric conversion element such as a photodiode outputs a current called a dark current even when no light is incident thereon. As a result, as described below, a phenomenon called drift occurs, in which the measurement value changes gradually over time. In wavelength ranges where the intensity of the incident light is low, it may become difficult to detect light waves with high sensitivity (graph 52 in FIG. 6).

To address this issue, it is known that an optical chopper can be used to measure the electrical signal outputted from a photoelectric conversion element in a state in which light is blocked and a state in which light is not blocked, and the difference between the two can be taken to suppress the effect of drift caused by the dark current. However, in a case in which the incident light to be measured is pulsed light that is outputted intermittently over a predetermined repetition period, the change in light intensity cannot be accurately captured unless the repetition period of the pulsed light is synchronized with the period for switching between blocking and not blocking light. As a result, a periodic error is mixed into the acquired optical spectral data, which may make it difficult to measure the optical spectrum of the incident light with high accuracy (graph 53 in FIG. 6).

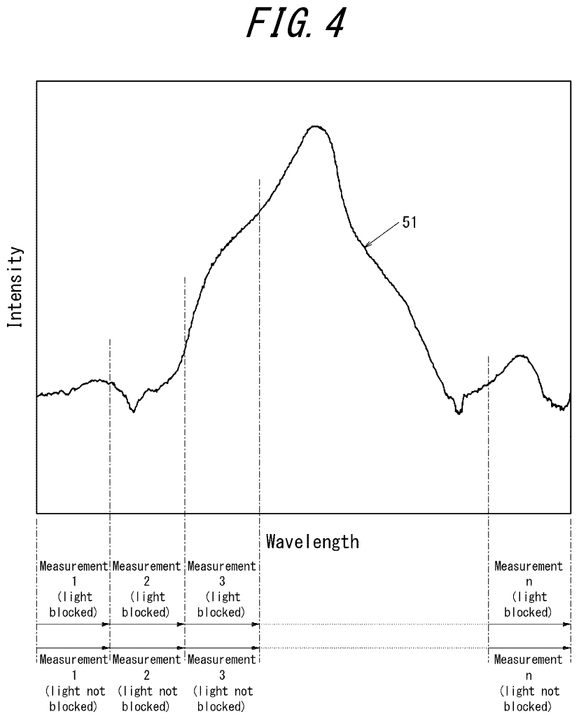

Therefore, the measurement apparatus 10 according to the present embodiment divides the entire wavelength interval to be measured into wavelength intervals that correspond to a period that is longer than the repetition period of the pulsed light and in which the effect of drift in the photodetector 13 is sufficiently small (see FIG. 4). The measurement apparatus 10 measures the optical spectrum in a state in which light is blocked and a state in which light is not blocked in each wavelength interval and acquires spectral data in which the effect of dark current is suppressed by subtracting the measurement value in the state in which light is blocked from the measurement value in the state in which light is not blocked. The measurement apparatus 10 combines the spectral data for each wavelength interval to acquire spectral data for the entire wavelength interval.

In this way, the measurement apparatus 10 of the present embodiment can offset the effect of dark current by subtracting the optical spectrum measured in a state in which light is blocked from the optical spectrum measured in a state in which light is not blocked, making it possible to measure the optical spectrum with high sensitivity even in wavelength ranges where the signal strength is weak. Furthermore, by performing measurements for each wavelength interval, the measurement apparatus 10 can shorten the time required for each measurement and suppress the effect on the measured spectral data of drift caused by dark current that occurs during measurement.

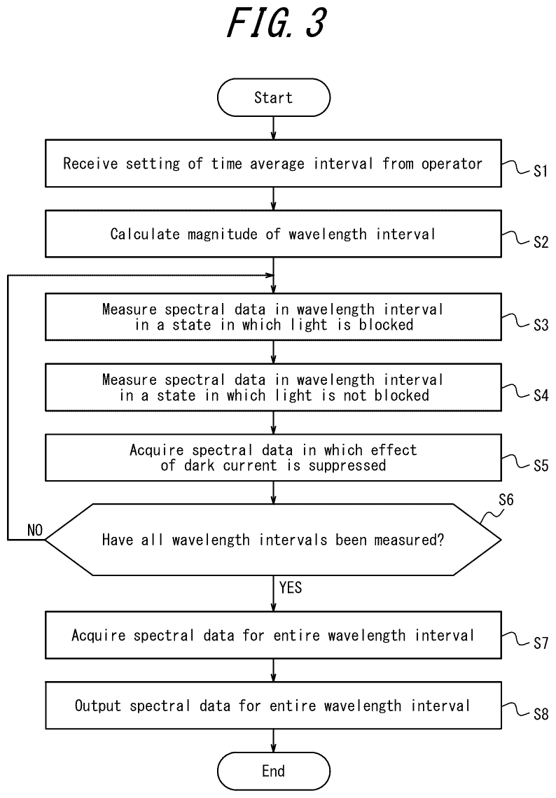

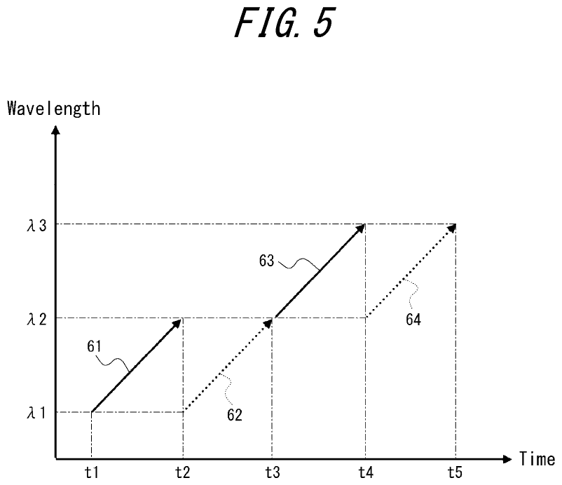

An example of the operation of the measurement apparatus 10 will be described with reference to FIGS. 3 to 5. FIG. 3 is a flowchart illustrating an example of the operation of the measurement apparatus 10 according to an embodiment. FIGS. 4 and 5 are schematic diagrams illustrating an example of the operation of the measurement apparatus 10 according to an embodiment. The operation of the measurement apparatus 10 described with reference to FIGS. 3 to 5 may correspond to one of the measuring methods of the measurement apparatus 10. The operations of each step in FIG. 3 may be executed under the control of the processor 16 of the measurement apparatus 10.

In step S1 of FIG. 3, the processor 16 receives a setting of a time average interval from the operator.

As described above, the measurement apparatus 10 performs measurements by dividing the entire measurement interval into short wavelength intervals (see FIG. 4). Therefore, the measurement apparatus 10 receives, from the operator, a setting of a time average interval that corresponds to the repetition period of the pulsed light that is the incident light.

The time average interval is the interval used to calculate the measurement value of one point. The measurement apparatus 10 calculates, for each time average interval, the average value of the light intensity measured by the photodetector 13 in a state in which light is blocked, and an average value of the light intensity measured by the photodetector 13 in a state in which light is not blocked. The measurement apparatus 10 acquires, for each time average interval, a measurement value of light intensity that suppresses the effect of dark current by subtracting the average value of the light intensity measured in a state in which light is blocked from the average value of the light intensity measured in a state in which light is not blocked. That is, the time average interval corresponds to the sampling interval of the light intensity.

The operator sets a time value (ms) greater than the repetition period of the pulsed light as the time average interval. By setting the time average interval to a value sufficiently larger than the repetition period of the pulsed light (for example, five or more times the repetition period), the ON/OFF ratio of the pulsed light can be kept approximately the same during measurements in the state in which light is blocked and the state in which light is not blocked. However, if the value of the time average interval is too large, the sampling interval becomes large, and the effect of drift caused by the dark current in the photodetector 13 can no longer be ignored. Therefore, the operator sets an appropriate value as the time average interval depending on the characteristics of the photodetector 13, the required measurement accuracy, and the like.

In step S2, the processor 16 calculates the size of the wavelength interval from the time average interval for which the setting was received in step S1.

Specifically, the processor 16 calculates the wavelength interval (number of points) using the following Equation 1.

wavelength interval (number of points)=drift allowable time (ms)/time average interval (ms) (Equation 1)

Here, the drift allowable time is the time between measurement in a state in which light is blocked and measurement in a state in which light is not blocked in a divided interval. The time during which the effect of drift caused by dark current in the photodetector 13 can be ignored is set in advance in the memory 17 as the drift allowable time according to the characteristics, temperature, and the like of the photodetector 13. For example, in a case in which the drift allowable time is 1000 ms and the time average interval is 10 ms, the wavelength interval is 100 points.

The processor 16 divides the entire range of the wavelengths to be measured into n wavelength intervals. FIG. 4 illustrates a wavelength range divided into n wavelength intervals. In FIG. 4, the horizontal axis represents wavelength. The vertical axis represents the intensity of the electrical signal outputted from the photodetector 13 in response to incident light. In steps S3 to S6, the processor 16 acquires spectral data in which the effect of dark current is suppressed for each of the n wavelength intervals by measuring in a state in which light is blocked and a state in which light is not blocked.

Hereinafter, for k=1, . . . , n, the k^{th} wavelength interval may be referred to as “wavelength interval k”. In FIG. 4, “measurement k (light blocked)” indicates the measurement of the optical spectrum in the state in which light is blocked in wavelength interval k. “Measurement k (light not blocked)” indicates the measurement of the optical spectrum in the state in which light is not blocked in wavelength interval k. The time required to measure one wavelength interval in each of the state in which light is blocked and the state in which light is not blocked corresponds to the drift allowable time.

FIG. 5 illustrates the relationship between the passage of time and the wavelength of the incident light whose intensity is being measured. In FIG. 5, the horizontal axis indicates time. The vertical axis indicates the wavelength of the incident light. A graph 61 illustrates how the intensity of incident light from wavelength λ1 to wavelength λ2 is measured from time t1 to time t2 in a state in which light is blocked. A graph 62 illustrates how the intensity of incident light from wavelength λ1 to wavelength λ2 is measured from time t2 to time t3 in a state in which light is not blocked. A graph 63 illustrates how the intensity of incident light from wavelength λ2 to wavelength λ3 is measured from time t3 to time t4 in a state in which light is blocked. A graph 64 illustrates how the intensity of incident light from wavelength λ2 to wavelength λ3 is measured from time t4 to time t5 in a state in which light is not blocked.

In FIG. 5, the graphs 61 and 62 from time t1 to t3 illustrate measurements in wavelength interval k. The graphs 63 and 64 from time t3 to t5 illustrate measurements in wavelength interval (k+1). Here, the time (t2−t1), the time (t3−t2), the time (t4−t3), and the time (t5−t4) each correspond to the drift allowable time. For each wavelength interval, the measurement apparatus 10 acquires the average of the measurement values in the state in which light is blocked and the state in which light is not blocked for each time average interval, the setting of which was accepted in step S1, and calculates the difference between the two to acquire spectral data in which the effect of dark current has been suppressed. As a result, the measurement values of the light intensity for the number of points calculated in step S2 are acquired for each wavelength interval.

An example of the operation for acquiring spectral data in wavelength interval k will be described below in the order of k=1, 2, . . . , n. The processor 16 sets the initial value of k to 1 and executes the processes from step S3 onwards.

In step S3, the processor 16 acquires spectral data in wavelength interval k in a state in which light is blocked. Specifically, the processor 16 measures the intensity of the incident light while rotating the diffraction grating 113 according to the drift allowable time and the wavelength range to be measured in the wavelength interval k. The processor 16 averages the measurement values for each time average interval set in step S1 to acquire the spectrum of the intensity of the incident light measured over the time average interval.

In step S4, the processor 16 acquires spectral data in wavelength interval k in a state in which light is not blocked. Specifically, as in step S3, the processor 16 measures the intensity of the incident light while rotating the diffraction grating 113 according to the drift allowable time and the wavelength range to be measured in the wavelength interval k. The processor 16 averages the measurement values for each time average interval set in step S1 to acquire the spectrum of the intensity of the incident light measured over the time average interval.

In step S5, the processor 16 subtracts the spectral data in the state in which light is blocked, as acquired in step S3, from the spectral data in the state in which light is not blocked, as acquired in step S4, to acquire spectral data in which the effect of dark current in the wavelength interval k is suppressed. Specifically, for each of the incident light intensities measured by averaging for each time average interval, the processor 16 subtracts the measurement value in the state in which light is blocked from the measurement value in the state in which light is not blocked to acquire the optical spectrum in the wavelength interval k.

In step S6, the processor 16 determines whether all wavelength intervals have been measured. Specifically, the processor 16 determines whether spectral data in which the effect of dark current is suppressed has been acquired for all of the wavelength intervals 1 to n. In a case in which all wavelength intervals have been measured (YES in step S6), the processor 16 proceeds to step S7. Otherwise (NO in step S6), the processor 16 increments the value of k by 1 and returns to step S3.

In step S7, the processor 16 combines the optical spectral data for each wavelength interval measured by the processes in steps S3 to S6 to acquire spectral data for the entire wavelength interval.

In step S8, the processor 16 outputs the spectral data for the entire wavelength interval acquired in step S7. Specifically, for example, the processor 16 may output the spectral data for the entire wavelength range to the memory 17 for storage. The processor 16 may output the spectral data for the entire wavelength range to the display 18 for display. The processor 16 may output the spectral data for the entire wavelength range to a storage medium such as a Universal Serial Bus (USB) memory or to another apparatus. When the process of step S8 is completed, the processor 16 ends the process of the flowchart in FIG. 3.

FIG. 6 is a diagram illustrating an example of measurement results of the optical spectrum of pulsed light for each measurement method. In FIG. 6, the horizontal axis represents wavelength. The vertical axis represents the intensity of the incident light. In FIG. 6, the vertical axis represents light intensity in logarithmic decibel milliwatts (dBm).

In FIG. 6, the graph 51 illustrates an example of an optical spectrum obtained by measuring the same incident light using the measurement apparatus 10. The graph 52 illustrates an example of the optical spectrum obtained by measuring the same incident light without using the optical chopper 12. The graph 53 illustrates an example of the optical spectrum obtained by measuring the same incident light by using the optical chopper 12 to block or not block light at a period not synchronized with the repetition period of the pulsed light.

The actual incident light has a complex spectral shape not only in the central frequency region, but also in the low and high frequency regions. In contrast, the graph 52 has a nearly horizontal shape in the low and high frequency regions. This indicates that, as a result of measurement without using the optical chopper 12, information on minute light intensity in the low and high frequency regions is lost due to errors caused by drift resulting from dark current. The graph 53 has a shape roughly similar to the true spectrum of the incident light, but exhibits errors in which the intensity increases and decreases at certain wavelength intervals. This indicates that periodic errors are mixed into the acquired optical spectral data because the repetition period of the pulsed light is not synchronized with the period at which the light is blocked and not blocked.

In contrast to these graphs, the graph 51, which is the measurement result from the measurement apparatus 10, has a shape that is roughly similar to the true spectrum of the incident light. This is because graph 51 measures low intensity components in the low and high frequency regions with high sensitivity without including periodic errors, as in the graph 53. Therefore, the measurement apparatus 10 can generate measurement spectral data with higher sensitivity than the graph 52. Furthermore, the measurement apparatus 10 can generate more accurate measured spectral data that does not include periodic errors, as compared to the graph 53. Therefore, the measurement apparatus 10 can measure the optical spectrum of the pulsed light with higher accuracy.

As described above, the measurement apparatus 10 includes the spectroscope 11 that extracts a specific wavelength component from the incident light, the photodetector 13 that outputs a signal according to the intensity of the extracted wavelength component, and the processor 16. The measurement apparatus 10 acquires, for each wavelength interval in a plurality of wavelength intervals into which a wavelength range to be measured is divided, a first signal outputted from the photodetector 13 in a state in which light is blocked and a second signal outputted from the photodetector 13 according to the intensity of the incident light in a state in which light is not blocked. The measurement apparatus 10 outputs the difference between the second signal and the first signal as the optical spectrum of the wavelength interval.

In this way, the measurement apparatus 10 divides the wavelength range to be measured into a plurality of wavelength intervals, measures the incident light in a state in which light is blocked and a state in which light is not blocked for each wavelength interval, and outputs the difference between the measurement signals as the optical spectrum of the wavelength interval. Therefore, the measurement apparatus 10 can suppress the effect of drift in the measurement value due to the dark current and can measure the optical spectrum of the pulsed light with higher accuracy.

The length of each wavelength interval in the plurality of wavelength intervals may be determined according to the magnitude of fluctuation in the measurement value caused by the dark current in the photodetector 13 during measurement of the optical spectrum in the wavelength interval.

In this way, the length of each wavelength interval is determined according to the magnitude of the fluctuation in the measurement value due to the dark current in the photodetector 13. The measurement apparatus 10 can therefore effectively reduce the effect of drift in the measurement value due to the dark current.

The measurement apparatus 10 may divide the wavelength range to be measured by using, as the wavelength intervals, intervals received as a setting from an operator via the operation interface 19.

In this way, the measurement apparatus 10 divides the wavelength range to be measured by using, as the wavelength intervals, intervals received as a setting from the operator, thereby enabling the operator to set the desired wavelength interval according to the characteristics of the photodetector 13 and measure the optical spectrum.

The measurement apparatus 10 may receive a setting of a time average interval from the operator via the operation interface 19. For each wavelength interval in the plurality of wavelength intervals, the measurement apparatus 10 may acquire, as the first signal, a signal obtained by averaging the signals outputted from the photodetector 13 in a state in which light is blocked in each time average interval. The measurement apparatus 10 may acquire, as the second signal, a signal obtained by averaging the signals outputted from the photodetector 13 in a state in which light is not blocked in each time average interval.

In this way, the measurement apparatus 10 receives the time average interval setting from the operator and acquires the optical spectrum for each wavelength interval based on the averaged signals for each time average interval. Thus, the operator can measure the optical spectrum at the desired sampling rate.

The measurement apparatus 10 may acquire, for each wavelength interval in the plurality of wavelength intervals, the first signal outputted from the photodetector 13 in a state in which light is blocked, and then acquire the second signal outputted from the photodetector 13 in a state in which light is not blocked.

In this way, the measurement apparatus 10 performs a measurement in a state in which light is blocked, and then performs a measurement in a state in which light is not blocked. Therefore, it is possible to minimize the effect of drift caused by dark current due to a rise in temperature of the photodetector caused by light being incident on the photodetector. The measurement apparatus 10 may perform a measurement in a state in which light is not blocked, and then perform a measurement in a state in which light is blocked.

The measurement apparatus 10 may further include the optical chopper 12 configured to block light incident on the photodetector 13. The measurement apparatus 10 may acquire, for each wavelength interval in the plurality of wavelength intervals, a signal outputted from the photodetector 13 in a state in which light is blocked by the optical chopper 12 as the first signal, and acquire a signal outputted from the photodetector 13 in a state in which light is not blocked by the optical chopper 12 as the second signal.

In this way, the measurement apparatus 10 can easily use the optical chopper 12 to switch between a state in which light is blocked and a state in which light is not blocked.

As described above, the measurement apparatus 10 can cancel out the effect of dark current by subtracting the measurement data in the state in which light is blocked from the measurement data in the state in which light is not blocked, thereby enabling the measurement apparatus 10 to measure the optical spectrum of incident light with high sensitivity. Furthermore, by measuring the optical spectrum for each wavelength interval, the measurement apparatus 10 can shorten the time required for each measurement and suppress the effect on the measured spectral data of drift caused by dark current that occurs during measurement.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

Also, for example, the configuration and operation of the measurement apparatus 10 may be distributed among a plurality of computers capable of communicating with each other. Also, for example, some or all of the components of the measurement apparatus 10 may be provided in another apparatus such as a PC (Personal Computer).

1. A measurement apparatus comprising:
a spectroscope configured to extract a specific wavelength component from incident light;
a photodetector configured to output a signal according to an intensity of the extracted wavelength component; and
a processor, wherein
the processor is configured to acquire, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and output a difference between the second signal and the first signal as an optical spectrum of the wavelength interval.

2. The measurement apparatus according to claim 1, wherein the length of each wavelength interval in the plurality of wavelength intervals is determined according to a magnitude of fluctuation in a measurement value caused by a dark current in the photodetector during measurement of the optical spectrum in the wavelength interval.

3. The measurement apparatus according to claim 1, wherein the processor is configured to divide the wavelength range to be measured by using, as the wavelength intervals, intervals received as a setting from an operator via an operation interface.

4. The measurement apparatus according to claim 1, wherein
the processor is configured to
receive a setting of a time average interval from an operator via an operation interface, and
acquire, for each wavelength interval in the plurality of wavelength intervals, a signal obtained by averaging signals outputted from the photodetector in a state in which light is blocked for each time average interval as the first signal, and a signal obtained by averaging signals outputted from the photodetector in a state in which light is not blocked for each time average interval as the second signal.

5. The measurement apparatus according to claim 1, wherein the processor is configured to acquire, for each wavelength interval in the plurality of wavelength intervals, the first signal outputted from the photodetector in a state in which light is blocked, and then acquire the second signal outputted from the photodetector in a state in which light is not blocked.

6. The measurement apparatus according to claim 1, further comprising
an optical chopper configured to block light incident on the photodetector, wherein
the processor is configured to acquire, for each wavelength interval in the plurality of wavelength intervals, a signal outputted from the photodetector in a state in which light is blocked by the optical chopper as the first signal, and acquire a signal outputted from the photodetector in a state in which light is not blocked by the optical chopper as the second signal.

7. A measurement method for a measurement apparatus comprising spectroscope configured to extract a specific wavelength component from incident light, a photodetector configured to output a signal according to an intensity of the extracted wavelength component, and a processor, the measurement method comprising:
acquiring, by the processor, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and outputting a difference between the second signal and the first signal as an optical spectrum of the wavelength interval.

8. The measurement method according to claim 7, wherein the length of each wavelength interval in the plurality of wavelength intervals is determined according to a magnitude of fluctuation in a measurement value caused by a dark current in the photodetector during measurement of the optical spectrum in the wavelength interval.

9. The measurement method according to claim 7, wherein the processor divides the wavelength range to be measured by using, as the wavelength intervals, intervals received as a setting from an operator via an operation interface.

10. The measurement method according to claim 7, wherein
the processor
receives a setting of a time average interval from an operator via an operation interface, and
acquires, for each wavelength interval in the plurality of wavelength intervals, a signal obtained by averaging signals outputted from the photodetector in a state in which light is blocked for each time average interval as the first signal, and a signal obtained by averaging signals outputted from the photodetector in a state in which light is not blocked for each time average interval as the second signal.

11. The measurement method according to claim 7, wherein the processor acquires, for each wavelength interval in the plurality of wavelength intervals, the first signal outputted from the photodetector in a state in which light is blocked, and then acquires the second signal outputted from the photodetector in a state in which light is not blocked.

12. The measurement method according to claim 7, wherein
the measurement apparatus further comprises an optical chopper configured to block light incident on the photodetector, and
the processor acquires, for each wavelength interval in the plurality of wavelength intervals, a signal outputted from the photodetector in a state in which light is blocked by the optical chopper as the first signal, and acquires a signal outputted from the photodetector in a state in which light is not blocked by the optical chopper as the second signal.

13. A program for controlling a measurement apparatus, the measurement apparatus comprising a spectroscope configured to extract a specific wavelength component from incident light, a photodetector configured to output a signal according to an intensity of the extracted wavelength component, and a processor, the program being configured to control the measurement apparatus to execute processing comprising:
acquiring, for each wavelength interval in a plurality of wavelength intervals into which a wavelength range to be measured is divided, a first signal outputted from the photodetector in a state in which light is blocked and a second signal outputted from the photodetector according to the intensity of the incident light in a state in which light is not blocked, and outputting a difference between the second signal and the first signal as an optical spectrum of the wavelength interval.

14. The program according to claim 13, wherein the length of each wavelength interval in the plurality of wavelength intervals is determined according to a magnitude of fluctuation in a measurement value caused by a dark current in the photodetector during measurement of the optical spectrum in the wavelength interval.

15. The program according to claim 13, wherein the processing comprises dividing the wavelength range to be measured by using, as the wavelength intervals, intervals received as a setting from an operator via an operation interface.

16. The program according to claim 13, wherein the processing comprises
receiving a setting of a time average interval from an operator via an operation interface, and
acquiring, for each wavelength interval in the plurality of wavelength intervals, a signal obtained by averaging signals outputted from the photodetector in a state in which light is blocked for each time average interval as the first signal, and a signal obtained by averaging signals outputted from the photodetector in a state in which light is not blocked for each time average interval as the second signal.

17. The program according to claim 13, wherein the processing comprises acquiring, for each wavelength interval in the plurality of wavelength intervals, the first signal outputted from the photodetector in a state in which light is blocked, and then acquiring the second signal outputted from the photodetector in a state in which light is not blocked.

18. The program according to claim 13, wherein
the measurement apparatus further comprises an optical chopper configured to block light incident on the photodetector, and
the processing comprises acquiring, for each wavelength interval in the plurality of wavelength intervals, a signal outputted from the photodetector in a state in which light is blocked by the optical chopper as the first signal, and acquiring a signal outputted from the photodetector in a state in which light is not blocked by the optical chopper as the second signal.
